(19) United States
(12) Patent Application Publication
(10) Pub. No.: US 2022/0156123 A1
(43) Pub. Date: May 19, 2022

(54) DATA MESH SEGMENTED ACROSS CLIENTS, NETWORKS, AND COMPUTING INFRASTRUCTURES

(71) Applicant: Intel Corporation, Santa Clara, CA (US)

(72) Inventors: Valerie J. Parker, Portland, OR (US); Daviann Angelica Duarte, Portland, OR (US); Ty H. Tang, San Francisco, CA (US)

(73) Assignee: Intel Corporation, Santa Clara, CA (US)

(21) Appl. No.: 17/592,351

(22) Filed: Feb. 3, 2022

(51) Int. Cl. G06F 9/50; G06F 11/30

(52) U.S. Cl. CPC G06F 9/5072; G06F 11/3051; G06F 11/3006; G06F 9/5077

(57) ABSTRACT

An apparatus includes a processor to receive a plurality of telemetry datasets from a plurality of infrastructure processing units (IPUs) in a computing infrastructure. Each of the plurality of IPUs is operably coupled to a plurality of devices having a particular device type. The plurality of telemetry datasets includes a first telemetry dataset received from a first IPU and a second telemetry dataset received from a second IPU. The processor is to store first telemetry data from the first telemetry dataset in a data store, store second telemetry data from the second telemetry dataset in the data store, and in response to receiving a telemetry data request that specifies a first identifier identifying the first IPU and a job identifier, retrieve the first telemetry data from the data store based, at least in part, on the first telemetry data being associated with the first identifier and the job identifier.

### TECHNICAL FIELD

The present disclosure relates in general to the field of computers, and more specifically, to a data mesh segmented across clients, networks, and computing infrastructures.

### BACKGROUND

Traditionally, hardware platforms in datacenters have included servers that are computing units composed of other components. For example, a compute server may include a central processing unit (CPU) along with other CPUs. A machine learning server may include a CPU along with graphics processing units (GPUs). A storage server may include a CPU along with solid state drives (SSDs) or hard disk drives (HDDs). In cloud computing services, hardware platforms are evolving into disaggregated elements that include general-purpose processors, heterogenous accelerators, homogeneous accelerators, network devices, and more.

### BRIEF DESCRIPTION OF THE DRAWINGS

FIG. 1 is a block diagram illustrating a data mesh segmented across clients, networks, and computing infrastructure, and associated systems according to at least one embodiment.

FIG. 2 is a block diagram of illustrating additional details of the data mesh of FIG. 1 according to at least one embodiment.

FIG. 3 is a simplified block diagram of example details of an infrastructure processing unit (IPU) according to at least one embodiment.

FIG. 4 is an example data structure in a data store containing telemetry data collections according to at least one embodiment.

FIG. 5 is a flowchart depicting example operations of an infrastructure processing unit (IPU) according to at least one embodiment.

FIG. 6 is a flowchart depicting example operations of a flow for receiving telemetry data from nodes in a computing infrastructure according to at least one embodiment.

FIG. 7 is a flowchart depicting example operations of a flow for responding to requests for collected telemetry data from a computing infrastructure according to at least one embodiment.

### DETAILED DESCRIPTION

The following disclosure provides various possible embodiments, or examples, for implementing features disclosed in this specification. In an embodiment, a data mesh is segmented across clients, networks, and computing infrastructures having disaggregated elements. The data mesh enables telemetry data from the disaggregated elements to be combined in a telemetry data platform. The telemetry data platform can provide services for enabling use case owners to retrieve telemetry data from disaggregated elements relevant to their use cases and to create meaningful key performance indicators (KPIs) for their use cases. Use cases can include, for example, workloads such containers, tenants, microservices, and other applications distributed across two or more of the disaggregated elements (e.g., compute nodes, storage nodes, memory nodes, accelerator nodes, network nodes, etc.). In one or more embodiments, a respective infrastructure processing unit (IPU) is coupled to each node of disaggregated elements to enable network communications between the node and other nodes, including the telemetry data platform, for example. The IPU also enables the collection of telemetry data related to the components of its associated node and communication of telemetry data reports to the telemetry data platform.

For purposes of illustrating the several embodiments of a data mesh segmented across clients, networks, and computing infrastructures, it is important to first understand the operations and activities associated with computing infrastructures and telemetry data in traditional datacenters. Accordingly, the following foundational information may be viewed as a basis from which the present disclosure may be properly explained.

System management and telemetry data exposure for datacenter servers, which are typically compute units composed of other heterogenous platform components (e.g., CPUs, GPUs, SSDs, NICs, etc.), are generally at the server platform level. Telemetry data from such servers may include server load, memory consumption, disk usage and input/output performance, system faults, and the like. Although workload solutions, applications, and microservices can be spread across multiple server nodes, networks, or clusters, available telemetry data and metrics are mostly server-centric and not directly applicable for meaningful use case key performance indicators (KPIs).

More recently, hardware platforms in computing infrastructures, such as cloud service datacenters, have been evolving into disaggregated elements. For example, a compute node may include two or more general-purpose processors (e.g., CPUs), an accelerator node may include two or more accelerators, a storage node may include two or more solid state devices (SSDs), a memory node may include two or more memory devices (e.g., dynamic random access memory (DRAM) device), and a network node may include two or more network devices (e.g., router, switch, gateway, etc.). Although a general-purpose processor may not be provisioned to manage disaggregated elements in each node, telemetry data associated with the disaggregated elements is still server-centric and not combined or attainable in any useful manner for use case owners and other entities that need relevant telemetry across nodes, for example, to enable debugging (e.g., of clusters) and resolutions for particular use cases.

A data mesh segmented across clients, networks, and computing infrastructures as disclosed herein resolves the aforementioned issues (and more). In one or more embodiments, a data mesh is configured to combine telemetry data from different infrastructure processing units (IPUs) into a telemetry data platform. Each IPU in the data mesh is coupled to a respective node of disaggregated elements and can be assigned a unique identifier per device element. Thus, in at least one scenario, the device ID would be unique across all computing infrastructures associated with the same telemetry data platform or the same group of telemetry data platforms. IPUs can manage their own monitoring, alerting, logging, collecting, and publishing (e.g., via application programming interfaces (APIs) to a telemetry data platform) telemetry data associated with the disaggregated elements of the node. IPUs can also manage the network communications associated with the node. The telemetry data may be published to the telemetry data platform in a consumable, predetermined format. The telemetry data platform can be configured to arrange and store the published telemetry data from the IPUs by functional categories and to accelerate data queries of the telemetry data. The telemetry data platform can further expose the telemetry data to authorized entities (e.g., use case owners, self-monitoring applications, etc.), manage secure access to the telemetry data, and administer authorized entities' API requests for retrieving the telemetry data from the various IPUs in the mesh. The telemetry data obtained from two or more disaggregated nodes can be accessed by authorized entities to create meaningful KPIs for their use cases (e.g., workload solutions, applications, microservices, containers, tenants, etc.).

A data mesh segmented across clients, networks, and computing infrastructures as disclosed herein can offer numerous advantages. Previously inaccessible telemetry data in the data mesh can be obtained by an authorized entity and used to create KPIs for numerous beneficial purposes including, but not limited to, debugging of clusters and resolutions with appropriate data based on the use case. In addition, microservices can be enabled, including for example, prediction, location, latency, determinism, security, programming, timing, and artificial intelligence. A microservice may, for example, obtain telemetry data collected for IPU devices used by other microservices to maintain a real-time KPI dashboard. Another microservice could monitor network packet drops via collected telemetry data and predict network performance issues. Additionally, meaningful KPIs can be a foundation of artificial intelligence to enable data efficiencies and use of data in real-time.

KPIs for use cases, such as workload solutions including microservices, containers, tenants, and other applications, can be enormously beneficial to use case owners if the relevant telemetry related to the use cases can be harnessed. For example, KPIs such as application-specific metrics, latency between nodes, cloud-related issues, signaling information, mobility, a number and type of available connections, a range to handoff or offline, and user experience, among others, can provide use case owners with valuable insight into critical aspects of the quality and/or operation of use cases spread across computing infrastructures. KPIs can also be derived by use case owners to improve use case development and debugging.

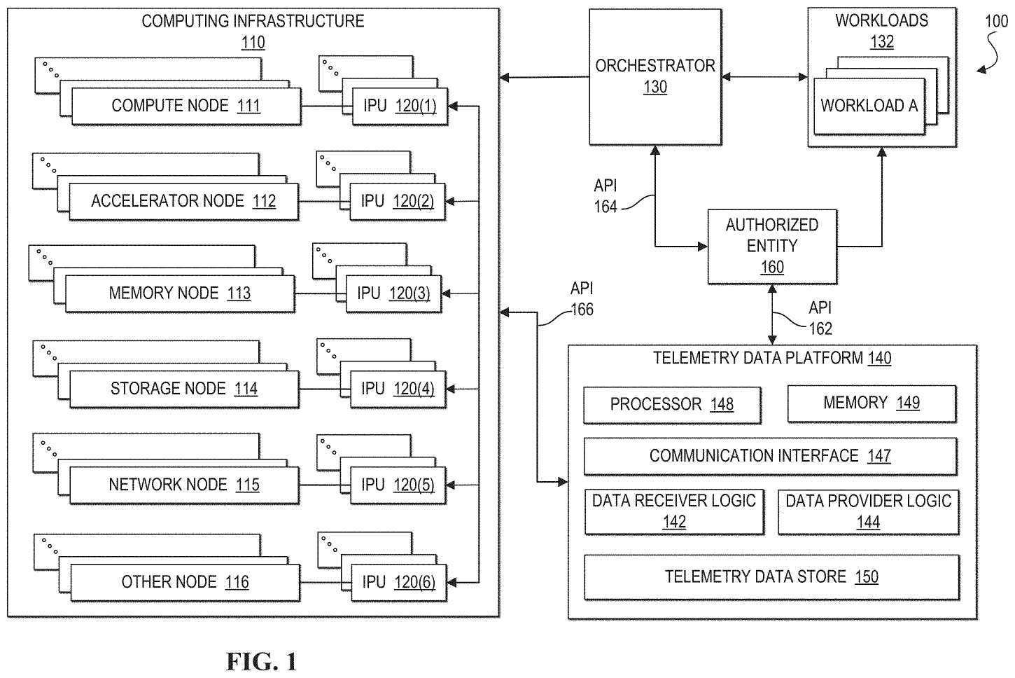

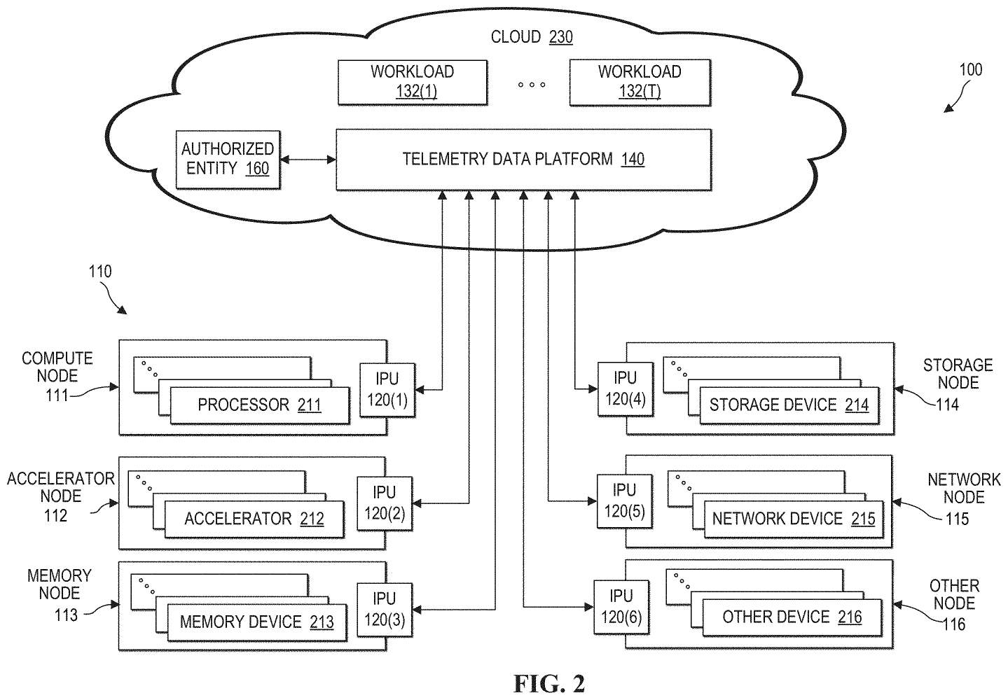

Referring now to the FIGURES, FIGS. 1-2 are block diagrams illustrating various details associated with a data mesh system 100 segmented across clients, network, and a computing infrastructure. As shown in FIG. 1, data mesh system 100 includes a computing infrastructure 110, a telemetry data platform 140 and associated systems according to at least one embodiment. An orchestrator 130 may be communicatively connected to computing infrastructure 110 to manage placement of a plurality of workloads 132 (e.g., workload A) in computing infrastructure 110. One or more authorized entities, such as an authorized entity 160, may communicate with telemetry data platform 140 via an application programming interface (API) 162 to retrieve relevant telemetry data associated with the authorized entity's use case(s). Use cases, such as microservice(s) and/or other application(s), may be included in workloads 132 and placed in computing infrastructure 110 by orchestrator 130.

Any of the elements of data mesh system 100 may be coupled together in any suitable manner such as through one or more networks. A network may be any suitable network or combination of one or more networks using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, an element of system 100 (e.g., orchestrator 130) may communicate through a network with external computing devices requesting the performance of processing operations (e.g., workloads) to be performed by computing infrastructure 110.

Computing infrastructure 110 includes a plurality of nodes containing disaggregated hardware components or elements (also referred to herein as “devices”). The nodes may include one or more compute nodes (e.g., a compute node 111), one or more accelerator nodes (e.g., an accelerator node 112), one or more memory nodes (e.g., a memory node 113), one or more storage nodes (e.g., a storage node 114), one or more network nodes (e.g., a network node 115), and/or one or more other nodes (e.g., other node 116). In a disaggregated computing infrastructure, such as computing infrastructure 110, multiple homogenous devices (e.g., hardware elements) may be contained in each node.

Referring briefly to FIG. 2, FIG. 2 is a block diagram illustrating some example details of data mesh system 100 including some additional details for nodes 111-116. In a computing infrastructure with disaggregated elements, typically, multiple homogenous devices are contained in each node. For example, compute node 111 may contain two or more general purpose processors, such as processor 211 (e.g., central processing units (CPUs)). Accelerator node 112 may contain two or more accelerators, such as accelerator 212 (e.g., graphics processing units (GPUs), inference accelerators, field programmable gate arrays (FPGAs)). In some scenarios, an accelerator node may contain the same accelerators, and in other scenarios, an accelerator node may contain a mixture of different types of accelerators and/or a general-purpose processor. Memory node 113 may contain two or more memory devices, such as memory device 213 (e.g., dynamic random access memory (DRAM)). Storage node 114 may contain two or more storage devices, such as storage device 214 (e.g., solid state device (SSD), hard drive device (HDD)). Network node 115 may contain two or more network devices, such as network device 215 (e.g., routers, switches, gateways). The other node 116 may contain any other devices, such as other device 216. Other devices may include suitable hardware components of a computing infrastructure, such as power supply elements, cooling elements, or other suitable components.

Although nodes in a disaggregated computing infrastructure may typically contain multiple homogeneous elements, it should be apparent that any one or more of the nodes may alternatively contain a single device. Furthermore, computing infrastructure 110 may be implemented with any suitable combination of compute nodes (e.g., 111), accelerator nodes (e.g., 112), memory nodes (e.g., 113), storage nodes (e.g., 114), network nodes (e.g., 115), and/or other nodes (e.g., 116), based on particular implementations and/or needs. Moreover, computing infrastructure 110 may comprise a datacenter (e.g., in the cloud, on premises, at the edge, etc.), a communications service provider (e.g., one or more portions of an Evolved Packet Core), or other suitable cluster of nodes. The telemetry data platform 140 may be provisioned in a cloud 230 in some embodiments, where workloads 132(1)-132(T) are deployed in computing infrastructure 110.

Referring again to FIG. 1, examples of possible devices in each of the nodes will now be described. For simplicity, the devices of particular nodes referenced in FIG. 1 (e.g., compute node 111, accelerator node 112, memory node 113, storage node 114, and network node 115) will be described. It should be understood, however, that one or more additional nodes may be provisioned in computing infrastructure 110 and could have the same or similar devices and configurations that are described.

A processor or processing device (e.g., processor 211) of compute node 111 may include a single-core or multi-core central processing unit (CPU), a microprocessor, embedded processor, a digital signal processor (DSP), a system-on-a-chip (SoC), a co-processor, or any other processing device to execute code. A processor in a compute node 111 may include any number of processing elements, which may be symmetric or asymmetric. In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

An accelerator (e.g., accelerator 212) of accelerator node 112 may include any suitable hardware and logic capable of accelerating certain workloads. An accelerator may be embodied as a processing device such as microprocessor that performs specialized processing tasks on behalf of one or more CPUs. Any specialized processing tasks may be performed by accelerators, such as graphics processing, cryptography operations, machine learning, vision processing, mathematical operations, TCP/IP processing, or other suitable functions. In particular configurations of computing infrastructure 110, accelerators may comprise programmable logic gates. For example, an accelerator may be embodied as a field-programmable gate array (FPGA). Other types of accelerators that may be included in computing infrastructure 110 can include graphics processing units (GPUs), vision processing units (VPUs), deep learning processors (DLPs), inference accelerators, and/or application-specific integrated circuits (ASICs), among others. In various configurations, accelerator node 112 may include multiple accelerators of the same type. In various other configurations, an accelerator node may include multiple accelerators of two or more different types. In some configurations, a CPU may be located on the same chip as the one or more accelerators and the accelerator(s) may be coupled to the CPU (or multiple CPUs) via a dedicated interconnect.

A memory device (e.g., memory device 213) of memory node 113 may include any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory devices in memory node 113 may be used for short, medium, and/or long term storage of a compute server or disaggregated memory node. Memory devices in memory node 113 may store any suitable data or information utilized by other elements of the computing infrastructure 110, including software embedded in a computer readable medium, and/or encoded logic incorporated in hardware or otherwise stored (e.g., firmware). Memory devices may store data that is used by processors of compute nodes 111, accelerators of accelerator node 112, and/or other processing elements in different nodes of computing infrastructure 110. In some embodiments, memory devices in memory node 113 may also comprise storage for instructions that may be executed by the processors of compute node 111, accelerators of accelerator node 112, and/or other processing elements in different nodes of computing infrastructure 110 to provide functionality associated with computing infrastructure 110. Memory devices may comprise one or more modules of system memory (e.g., RAM) coupled to the processors in compute node 111 and accelerators in accelerator node 112 through memory controllers (which may be external to or integrated with the processors and/or accelerators). In some implementations, one or more particular modules of memory may be dedicated to a particular processor in compute node 111, accelerator in accelerator node 112, other processing device in different nodes, or may be shared across multiple processor nodes, accelerator nodes, or other processing nodes.

A storage device (e.g., storage device 214) of storage node 114 may include any suitable characteristics described above with respect to memory devices in memory node 113. In particular embodiments, storage devices may comprise non-volatile memory such as one or more hard disk drives (HDDs), one or more solid state drives (SSDs), one or more removable storage devices, and/or other media. In particular embodiments, a storage device in storage node 114 is slower than a memory device in memory node 113, has a higher capacity, and/or is generally used for longer term data storage.

A network device (e.g., network device 215) of network node 115 may include any suitable characteristics for routing data over a network in computing infrastructure 110 and/or for routing data outside computing infrastructure 110. For example, network devices in network node 115 may include one or more of hubs, switches, routers, bridges, gateways, modems, and/or access points, among others. One or more network devices may couple to various ports (e.g., in IPUs 120(1)-120(6)) and may switch data between these ports and various elements of computing infrastructure 110 (e.g., via one or more Peripheral Component Interconnect Express (PCIe) lanes coupled to processors in compute node 111, accelerators in accelerator node 112, memory devices in memory node 113, storage devices in storage node 114, and/or other devices in the other node 116.

As shown in FIG. 1, each infrastructure processing unit (IPU) may be vertically integrated in computing infrastructure 110 and operably coupled to a particular node in computing infrastructure 110. More particularly, for example, IPU 120(1) is operably coupled to processors of compute node 111, IPU 120(2) is operably coupled to accelerators of accelerator node 112, IPU 120(3) is operably coupled to memory devices of memory node 113, IPU 120(4) is operably coupled to storage devices of storage node 114, IPU 120(5) is operably coupled to network devices of network node 115, and IPU 120(6) is operably coupled to the other devices of other node 116. In one or more embodiments, IPUs 120(1)-120(6) may be embodied as a high-performance software programmable central processing unit for support of infrastructure services, such as management, service mesh offload, distributed security services, storage, and networking.

IPUs 120(1)-120(6) can include a network interface for communicating signaling and/or data between nodes of computing infrastructure 110, networks coupled to computing infrastructure 110, other computing infrastructures (e.g., on premises, in the cloud, or anywhere in between), and/or devices coupled through such networks to the computing infrastructure. For example, network interfaces of IPUs 120(1)-120(6) may be used to send and receive network traffic such as data packets. In a particular example, network interfaces comprise one or more physical network interface controllers (NICs), network interface cards, smart NICs, or network adapters. A NIC may include electronic circuitry to communicate using any suitable physical layer and data link layer standard such as Ethernet (e.g., as defined by an IEEE 802.3 standard), Fibre Channel, InfiniBand, Wi-Fi, or other suitable standard. A NIC may include one or more physical ports that may couple to a cable (e.g., an Ethernet cable). A NIC may enable communication between any suitable element of computing infrastructure 110 and another device in the computing infrastructure or coupled to the computing infrastructure through a network.

Each IPU 120(1)-120(6) may also include a hardware interface for communicating to devices within the IPU's associated node. In one or more examples, a hardware interface may be represented via a layered protocol stack that includes logic implemented in hardware circuitry and/or software. Examples of a layered communication stack can include, but are not limited to, a peripheral component interconnect (PCIe) stack, a Quick Path Interconnect (QPI) stack, a next generation high performance computing interconnect stack, or other layered stack. Hardware interfaces to devices in the associated node may support other forms of interconnection such as a point-to-point interconnect, a serial interconnect, a multi-drop bus, a mesh interconnect, a ring interconnect, a parallel bus, a coherent (e.g., cache coherent) bus, a Gunning transceiver logic bus, or any other suitable communication mechanism.

IPUs 120(1)-120(6) may each have a unique identifier at least within computing infrastructure 110 (and potentially within a broader data mesh of additional computing infrastructures, clients, and/or clouds). In at least one embodiment, each IPU can manage its own functions related to its corresponding node. For example, IPU 120(1) can manage its own functions related to compute node 111, IPU 120(2) can manage its own functions related to accelerator node 112, IPU 120(3) can manage its own functions related to memory node 113, IPU 120(4) can manage its own functions related to storage node 114, IPU 120(5) can manage its own functions related to network node 115, and IPU 120(6) can manage its own functions related to the other node 116. In one or more embodiments, each IPU can perform functions such as monitoring hardware components in its corresponding node, alerting an appropriate receiver (e.g., Enterprise monitoring system, telemetry data platform, orchestrator) when errors, failures, or other issues are detected in telemetry data, collecting telemetry data from hardware components in the associated node, logging the collected telemetry data, generating telemetry datasets in a predetermined format, and publishing the telemetry datasets to telemetry data platform 140 via one or more application programming interfaces (APIs) 164. Telemetry data collected by an IPU can include telemetry data related to devices of the node coupled to the IPU, and telemetry data related to communications between the node (and its devices) coupled to the IPU and different nodes in computing infrastructure 110 or in other computing infrastructures or networks. In at least one embodiment, IPUs 120(1)-120(6) may use any suitable protocol(s) to communicate with telemetry data platform 140. In one example, one or more of the IPUs 120(1)-120(6) may use a representational state transfer (REST) application programming interface (API) 166 to publish telemetry data (and other related information) and metrics to telemetry data platform 140.

IPUs 120(1)-120(6) are operable to capture telemetry data from devices (and their interfaces) of their respective nodes 111-116. For example, telemetry data can be collected from processors (e.g., CPUs) in compute node 111, accelerators (e.g., GPUs, inference accelerators, FPGAs, etc.) in accelerator node 112, memory devices (e.g., DRAM, RAM, etc.) in memory node 113, storage devices (e.g., HDD, SSD, etc.) in storage node 114, and network devices (e.g., routers, hubs, gateways, switches, etc.) in network node 115. Telemetry data can also be collected from each interface that connects a device to one or more other device. By way of example, telemetry data can be collected from a CPU and its corresponding interface that connects it to the IPU or to another CPU. The CPU can have internal utilization and error metrics (e.g., for cores and caches) as well as interface utilization and error metrics (e.g., for double data rate (DDR) computer bus, point-to-point processor interconnect, peripheral component interconnect express (PCIe), and others).

IPUs 120(1)-120(6) may each be configured with one or more network interfaces and can be operable to capture telemetry data from their own network interface(s) that provides network communication to different nodes within the same computing infrastructure, nodes in other computing infrastructures (e.g., clouds, remote on premises datacenters, computing infrastructures in between, etc.), or nodes in other networks (e.g., a vehicle, handheld computing device, personal computer, laptop, etc.). For example, signaling information, latency, transmission errors, network interface controller (NIC) errors, and any other useful network telemetry data may be captured and logged by the IPUs.

In one or more embodiments, each IPU 120(1)-120(6) can generate a telemetry dataset that contains the telemetry data collected by that IPU and other relevant information. A telemetry dataset can contain an instance of telemetry data from a device (or its interface) of the node. In one or more embodiments, the telemetry dataset may include date and time information associated with telemetry data being reported, telemetry type information (type ID) indicating a type of telemetry data, device identifying information (device ID) uniquely identifying the device at least within the node, and the particular telemetry data itself. A telemetry dataset may also include an IPU identifier (IPU ID), which can uniquely identify the IPU that generates the dataset. A telemetry dataset may further include a job identifier (job ID), which can uniquely identify a workload that is associated with the telemetry data. The IPUs may generate respective telemetry datasets based on the same consumable configuration. The consumable configuration may include compression to optimize transmission of the data, and encryption to protect the data from unauthorized entities. The consumable configuration may embody any suitable schema or structure based on particular needs and implementations. Example include, but are not necessarily limited to, any ordered collection of data, tables, files that contain one or more records, tabular data, comma separated values (CSV) files, etc.

It should be apparent that numerous approaches may be used for a dataset configuration. Telemetry data collected by an IPU is associated with the IPU ID. However, each instance of telemetry data may be associated with different combinations of job ID, device ID, telemetry type ID, and data and time information. Accordingly, two or more instances of telemetry data having one or more similar parameters may be included in a single dataset. For example, multiple instances of the same telemetry data collected at different times during the execution of the same workload may be included in the one dataset with different date and time information for each instance of telemetry data. In another example, multiple instances of telemetry data that are related to a particular executing workload and collected at the same time (or within the same threshold of time) may be included in the same dataset with different device IDs and telemetry type IDs included for each instance of telemetry data. These nonlimiting examples illustrate some of the many possibilities for a consumable configuration of telemetry data and other relevant information to be created by the IPUs and published to telemetry data platform.

IPUs 120(1)-120(6) may communicate telemetry datasets to telemetry data platform 140 periodically (e.g., on an as needed basis) or at regularly scheduled intervals. In some scenarios, telemetry data platform 140 may request telemetry data from the IPUs periodically (e.g., on an as needed basis) or at regularly scheduled intervals. In some scenarios, datasets may be transmitted individually or as a combination of datasets. A combination of datasets may be published at regularly scheduled intervals, for example. Each IPU 120(1)-120(6) may use a suitable communication protocol to communicate the telemetry data to telemetry data platform 140. In some implementations, the IPUs of a particular computing infrastructure may use the same communication protocol when providing respective telemetry datasets to the telemetry data platform 140. In other embodiments, two or more different communication protocols may be used by the IPUs to provide telemetry datasets to the telemetry data platform 140.

Any suitable telemetry data may be collected. For example, the telemetry data may include, but is not necessarily limited to, usage data, input/output, bandwidth, latency between nodes, utilization metrics (e.g., the percentage of available resources being used such as CPU utilization, accelerator utilization, etc.), error metrics (e.g., error correction code (ECC), faults at a node, delta of a node), power information (e.g., power consumed during designated time periods and/or workloads), and/or temperature information (e.g., ambient air temperature) near the components of the computing infrastructure. One or more of these different types of telemetry data may be obtained for each of the hardware component, the interface of the hardware component, and the node containing the hardware component and its interface.

As specific (but non-limiting) examples, the telemetry data may include processor cache usage, accelerator cache usage, current memory bandwidth usage/consumption, and current I/O bandwidth use by each virtual guest system or part thereof (e.g., thread, application, microservice, etc.) and/or bandwidth of each I/O device (e.g., Ethernet device or hard disk controller). Further telemetry data could include the number of memory accesses per unit of time and/or per virtual guest system or part thereof (e.g., thread, application, microservice, etc.). Utilization metrics can measure the percentage of available resources being used per process (e.g., percentage of total computing power of a node limited to the percentage utilized by a process) or in the aggregate (e.g., percentage of the total computing power used by an individual processor or accelerator of a node.)

Additional telemetry data may include an amount of available memory space or bandwidth, an amount of available processor cache space or bandwidth, and/or an amount of available accelerator cache space or bandwidth. In addition, temperatures, currents, and/or voltages may be collected from various points of the computing infrastructure, such as at one or more locations of each core, one or more locations of chipsets associated with the processors in a computing node, one or more locations of chipsets associated with accelerators in an accelerator node, or other suitable locations of the computing infrastructure 110 (e.g., air intake and outflow temperatures may be measured).

Further telemetry data that may be collected can include any information related to correctable errors encountered by hardware components, their corresponding interfaces, and/or nodes containing the hardware components and interfaces. Error information can include, for example, the type of error and the frequency of errors for the component and/or node.

Yet further telemetry data can include a current level of redundancy used for maintaining different parts of a computing infrastructure in a functioning state. For example, the level of redundancy of particular hardware components within a node (e.g., number of redundant or backup CPUs in a compute node, number of redundant SSD devices in a memory node, number of GPUs in a GPU accelerator node, etc.), and/or the level of redundancy of particular nodes (e.g., compute node, memory node, accelerator node, network node, storage node) within a rack, floor, building, zone, etc. of the computing infrastructure or within the entire computing infrastructure, etc. may be obtained.

Yet further telemetry data can include resource utilization per application running on a node and/or particular hardware component. For example, the frequency that an application accesses a particular resource (e.g., system memory, main memory, network devices for remote communications, etc.) may be collected as part of telemetry data.

Telemetry data may also include metadata associated with the configuration of each node and/or its hardware components. As specific (but non-limiting) examples, metadata associated with a node can include age of the node (e.g., installation date, manufacturing date), types of hardware components in the node (e.g., types of processors, memory, storage, accelerators, etc.), and/or identification of installed software and possibly the date of the software installation. Metadata can also pertain to particular hardware components in a node. For example, the type of hardware component (e.g., manufacturer, product identifier, number of cores, size of cache, size of storage devices, size of memory, etc.). For replaceable hardware components in a node, metadata can be collected that includes the age of the hardware components if it differs from the age of the node itself. Metadata can also include location information (e.g., geographical location and/or indoor positioning within a data center). For example, geographical location information could include a physical address (e.g., street, city, state, country). Indoor positioning location information could include rack number, rack configuration (e.g., number of compute nodes), socket identification, node identification, etc.

In an embodiment, at least some IPUs (e.g., IPU 120(1) of compute node 111, IPU 120(2) of accelerator node 112) may include a performance monitor, e.g., Intel® performance counter monitor (PCM), to detect, for processors or accelerators, processor utilization, core operating frequency, and/or cache hits and/or misses. IPUs, such as IPU 120(3) of memory node 113, may be further configured to detect an amount of data written to and read from, e.g., memory controllers associated with processors (e.g., 211), accelerators (e.g., 212), memory devices (e.g., 213), storage devices (e.g., 214), and/or network devices (e.g., 215). In another example, at least some IPUs may include one or more Java performance monitoring tools (e.g., jvmstat, a statistics logging tool) configured to monitor performance of Java virtual machines, UNIX® and UNIX-like performance monitoring tools (e.g., vmstat, iostat, mpstat, ntstat, kstat) configured to monitor operating system interaction with physical elements.

In the embodiment depicted in FIG. 1 of data mesh system 100, telemetry data platform 140 includes a processor 148, a memory 149, a communication interface 147, data receiver logic 142, data provider logic 144, and a telemetry data store 150. Processor 148 may include any suitable combination of characteristics described herein with respect to processors of compute node 111 and/or accelerators of accelerator node 112. Memory 149 may include any suitable combination of characteristics described herein with respect to memory devices of memory node 113 and/or storage devices of storage node 114. For example, memory 149 may comprise storage for instructions that may be executed by one or more processors (e.g., processor 148) of telemetry data platform 140. Communication interface 147 may include any suitable combination of characteristics described herein with respect to network interfaces of IPUs 120(1)-120(6). Telemetry data store 150 can be stored in memory 149 or other storage element having any suitable combination of characteristics described herein with respect to storage devices of storage node 114. In one specific (non-limiting) example, telemetry data platform 140 could be implemented on a computational storage IPU with a custom application-specific integrated circuit (ASIC) to accelerate data queries to telemetry data store 150.

Telemetry data platform 140 may be configured to communicate with IPUs of computing infrastructure 110 and potentially the IPUs of one or more other computing infrastructures. Telemetry data platform 140 may be configured to communicate with IPUs, such as 120(1)-120(6), using any appropriate communication protocols. Communication interface 147 may include one or more network interfaces that are configured to use one or more suitable protocols to receive communications (e.g., telemetry datasets, alerts with critical telemetry data) from IPUs 120(1)-120(6) and to send communications (e.g., requests for telemetry data) to IPUs 120(1)-120(6). In one example, each IPU of a computing infrastructure in a data mesh system, such as IPUs 120(1)-120(6) of computing infrastructure 110 in data mesh system 100, may communicate using the same protocol, but IPUs of different computing infrastructures in the same data mesh system may use a different protocol to communicate with telemetry data platform 140. In other examples, different protocols may be used by IPUs of the same computing infrastructure. Any suitable network communication protocol may be used by IPUs 120(1)-120(6) to communicate with telemetry data platform 140 (and other systems). For example, each IPU may be configured to communicate using a different protocol. Examples of suitable network communication protocols may include, but are not necessarily limited to, hyper text transfer protocol (HTTP), transmission control protocol (TCP), and user datagram protocol (UDP), and more.

In at least one embodiment, data receiver logic 142 may be configured to receive telemetry datasets that are sent via the network by IPUs 120(1)-120(6). Data receiver logic 142 can apply appropriate decompression and decryption techniques to decompress and decrypt the telemetry datasets. In addition, data receiver logic 142 may be configured to transform the telemetry datasets into a standard format that enables fast retrieval for search queries. Any suitable data storage and retrieval system (e.g., database, tables, linked lists, distributed file system, object storage service, etc.) could be utilized for storing the telemetry data.

Telemetry data platform 140 may also be configured to communicate with one or more authorized entities, such as authorized entity 160, using any appropriate communication protocols. One or more network interfaces of communication interface 147 may be configured to use one or more suitable protocols to communicate with authorized entity 160 via application programming interfaces, such as API 162. APIs may be used by authorized entities, such as authorized entity 160, to request telemetry data related to a use case of the authorized entity. A use case could include, for example, a microservice or other application running on devices in nodes of the computing infrastructure 110. An API may be used to request telemetry data related to the use case to enable evaluation, debugging, or monitoring of the use case, independently or as part of a cluster of applications or microservices, and to develop any needed resolutions. Any suitable network communication protocol or pattern may be used by authorized entities to communicate with telemetry data platform 140. Examples of suitable network communication protocols may include, but are not necessarily limited to, hyper text transfer protocol (HTTP). Examples of suitable APIs include, but are not necessarily limited to, SOAP protocol and REST architectural pattern, both of which can use HTTP for sending requests and receiving responses over a network.

In at least one embodiment, data provider logic 144 may be configured to receive requests for telemetry data related to particular use cases, which are sent by an authorized entity (e.g., authorized entity 160) using an API (e.g., API 162). Requesting entity 160 represents any consumer of the telemetry data, which could include, but is not necessarily limited to, a use case owner, the job or application itself for which telemetry data is requested, data and/or log analytics software, or microservices health monitoring and alerting software tools. In at least one embodiment, the request may specify one or more IPU IDs.

The IPU IDs associated with a particular workload may be identified by querying the orchestrator 130. When a workload is scheduled in the computing infrastructure 110, orchestrator 130 can return a job ID. In one or more embodiments, the authorized entity 160 can pass the job ID to orchestrator 130 via an API, such as API 166, to obtain the IPU IDs of the IPUs to which the workload was deployed. The telemetry data request may also include one or more parameters representing categories of other information relevant to the telemetry data being requested. For example, the one or more other parameters in the request could include a date and time (or time period), job ID, a telemetry type ID, and/or a device ID. The authorized entity may submit a telemetry data request specifying any IPU ID(s) for which the entity has authorization to access its telemetry data, along with any combination of other parameters. In some scenarios, the authorized entity may request all telemetry data for a particular workload based on the job ID.

Orchestrator 130 is configured to activate, control, and configure the hardware elements (or devices) of computing infrastructure 110. The orchestrator 130 is configured to manage combining computing infrastructure hardware elements into logical machines, e.g., to configure the logical machines. The orchestrator 130 is further configured to manage placement of workloads, such workloads 132, onto the logical machines, e.g., to select a logical machine on which to place a respective workload (e.g., workload A) and to manage logical machine sharing by a plurality of workloads (e.g., workloads 132). Orchestrator 130 may correspond to a cloud management platform, e.g., OpenStack® (cloud operating system), CloudStack® (cloud computing software) or Amazon Web Services (AWS). Various operations that may be performed by orchestrator 130 include selecting one or more nodes for the instantiation of a virtual machine, container, or other workload and directing the migration of a virtual machine, container, or other workload from particular hardware elements or logical machines to other hardware elements or logical machines. Orchestrator 130 may comprise any suitable logic. In various embodiments, orchestrator 130 comprises a processor operable to execute instructions stored in a memory and any suitable communication interface to communicate with computing infrastructure 110 to direct workload placement and perform other orchestrator functions.

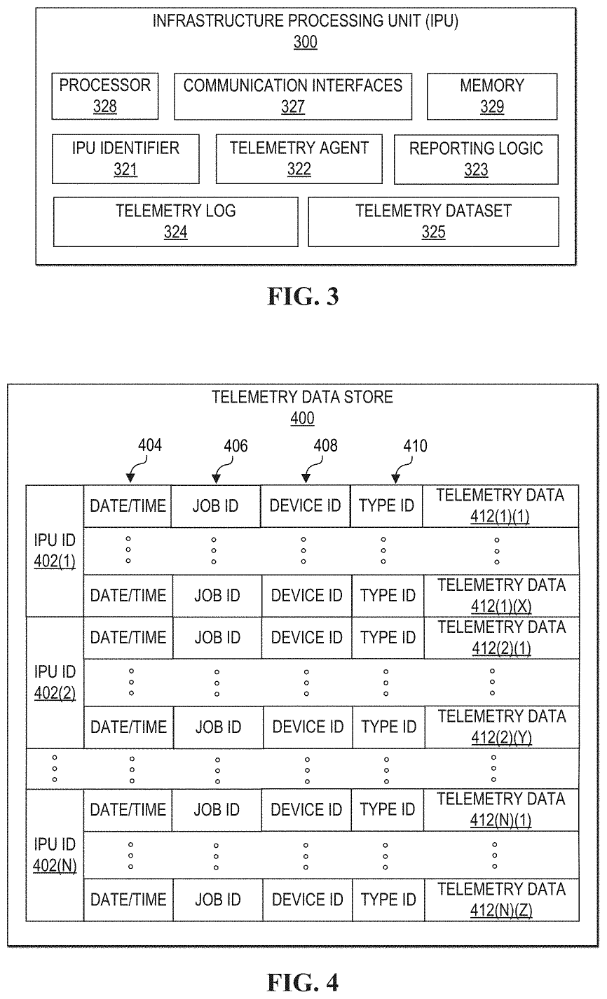

FIG. 3 is a block diagram illustrating possible details of an example infrastructure processing unit (IPU) 300 according to at least one embodiment. IPU 300 represents a possible implementation of IPUs in computing infrastructure 110, such as IPUs 120(1)-120(6), and may have any suitable characteristics as described with reference to such IPUs. In this example, IPU 300 includes communication interfaces 327 (e.g., NIC), a processor 328, and a memory 329. Memory 329 may have any suitable characteristics as described herein with reference to memory devices (e.g., 213) of memory node 113 and/or storage devices (e.g., 214) of storage node 114. Processor 328 may have any suitable characteristics as described herein with reference to processors (e.g., 211) of compute node 111 and/or accelerators (e.g., 212) of accelerator node 112. In one or more examples, processor 328 may be embodied as a high-performance software programmable multi-core CPU (or other high-performance processor) that support infrastructure services, such as management, service mesh offload, distributed security services, storage, and networking. In one or more embodiments, IPU 300 may be embodied as a data processing unit (DPU), which can include a programmable electronic circuit with hardware acceleration of data processing for data-centric computing and one or more high-performance network interfaces. In accordance with the broad concepts of the present disclosure, any of the embodiments described herein may be implemented with one or more DPUs.

Communication interfaces 327 may include an interface to communicate with devices contained in the node associated with IPU 300 and may have any suitable characteristics as described herein with reference to hardware interfaces of IPUs 120(1)-120(6), such as various interconnect interfaces (e.g., PCIe, Quick Path, point-to-point, etc.). Communication interfaces 327 may also include a network interface that includes any suitable characteristics as described herein with reference to network interfaces of IPUs 120(1)-120(6) such as network interface controllers (NICs), smart NICs, network adapters, and/or other high-performance network interfaces/controllers.

In one or more embodiments, IPU 300 may also contain an IPU identifier 321, a telemetry agent 322, reporting logic 323, a telemetry log 324, and telemetry dataset 325. The IPU identifier 321 of IPU 300 may be unique among other IPUs in a computing infrastructure, such as computing infrastructure 110, or it may be unique among other IPUs in multiple computing infrastructures. In one or more embodiments, the IPU identifier 321 may be assigned to IPU 300 by an orchestrator (e.g., orchestrator 130) and may be linked to one or more job identifiers at various times. A job identifier (job ID) may be a unique reference for a workload (e.g., microservice, application, container, tenant, etc.) and may be generated by an orchestrator that provisions and deploys the workload to run on multiple nodes in the computing infrastructure, such as the node coupled to IPU 300. Additionally, the IPU identifier 321 may be linked to device identifiers assigned to each device in the node coupled to IPU 300. For example, if IPU 300 is coupled to a compute node, respective device identifiers could be assigned to each CPU in the compute node, and each CPU device identifier could be linked to IPU identifier 320 and to any job identifiers of workloads provisioned on that CPU.

Telemetry agent 322 can be configured to perform various functions and may include one or more algorithms to accomplish the functions. For example, telemetry agent 322 may perform functions such as monitoring devices in the node coupled to IPU 300 and monitoring the communication interfaces 327 of IPU 300. Telemetry agent 322 may also comprise collection algorithms for collecting relevant telemetry data from devices in the associated node and from communication interfaces 327. Telemetry agent 322 may be configured further to log collected telemetry data in telemetry log 324 and to alert the telemetry data platform, the orchestrator, and/or a central Enterprise monitoring system when critical telemetry data (e.g., indicating system issues/failure or hardware replacement needs, etc.) has been collected. In one example, a telemetry data platform could raise a flashing red flag on its user interface panel and/or an orchestrator could include an alert notification as part of an output log. In another example, a memory IPU of ECC (error correction code) DRAM DIMMs (dual in-line memory modules) could be configurable to create and send an alert event to an Enterprise monitoring system when a DIMM experiences more than a configurable threshold number of ECC errors per threshold amount of time (e.g., per minute), as such telemetry data may indicate that the DIMM is degrading.

Telemetry agent 322 may be embodied as logic that includes data processing algorithms to generate telemetry datasets with collected telemetry data that is stored in the telemetry log 324. In one possible embodiment, each instance of telemetry data in telemetry log 324 may be stored in a record or row (or other suitable data storage structure), along with other relevant information. Other relevant information could include, for example, IPU identifier 321, date and time information, a device identifier (device ID) of the device corresponding to the telemetry data, a job identifier (job ID) of the workload provisioned on the device, and (optionally) a telemetry type identifier (telemetry type ID). In at least one embodiment, telemetry agent 322 may select one row to form a telemetry dataset 325 to be published to a telemetry data platform (e.g., 140), either individually or combined with other datasets. In other scenarios, any two or more records may be selected for the telemetry dataset 325. For example, the selected group of records may include telemetry data collected during a certain period of time, telemetry data collected from a particular device or elements in the node, telemetry data of a particular type, telemetry data based on any other suitable selection criteria, or any combination thereof. Once a record or group of records is selected, telemetry agent 322 can generate telemetry dataset 325, based on the selected record or group of records, using a predetermined format that is consumable by a telemetry data platform (e.g., 140). In at least one embodiment, compression techniques may be applied to the dataset or combination of datasets to save bandwidth and storage space by shortening the size of the dataset or combination of datasets. In addition, encryption may be applied to the dataset or combination of datasets to maintain the security of the information contained in the dataset or combination of datasets. Any suitable type of encryption (e.g., asymmetric or symmetric) may be used including, but not limited to, Advanced Encryption Standard (AES), block cipher (e.g., Rivest Cipher, Speck, Simon, etc.), Data Encryption Standard (DES), Rivest-Shamir-Adleman (RSA), Diffie-Hellman, and more.

In some embodiments, telemetry agent 322 may collect telemetry data continuously. In other embodiments, telemetry agent 322 may collect telemetry data at defined intervals and/or in response to instructions from a telemetry data platform to retrieve telemetry data for a particular application, microservice application, container, or tenant, or to retrieve telemetry data based on any other combination of parameters (e.g., job ID, device ID, date and time or time period, and/or telemetry type ID).

Reporting logic 323 may be configured to cause the encrypted and compressed telemetry dataset 325 (or combination of datasets) to be communicated to a telemetry data platform (e.g., 140). IPU 300 can be configured to use any suitable protocol accepted by the telemetry data platform. In some embodiments, reporting logic 323 may send datasets (e.g., 325) to the telemetry data platform in a continuous feed. In other embodiments, reporting logic 323 may send datasets to the telemetry data platform at defined intervals. In yet other embodiments, reporting logic 323 may send datasets to the telemetry data platform periodically, as needed (e.g., in response to a request from the telemetry data platform to retrieve telemetry data for a particular application, microservice application, container, or tenant, or for any combination of parameters) or as the amount of collected telemetry data accumulates to a certain threshold. In some cases, IPU 300 may be configured to report telemetry data immediately when a critical event is detected (e.g., when an event causes an alert to be sent to a user, an orchestrator, or other entity that receives such information).

In a further embodiment, communication interfaces 327 of a single IPU 300 may include multiple interconnect interfaces and/or network interfaces that connect IPU 300 to respective groups of devices associated with different device types. For example, IPU 300 may contain a first communication interface that communicatively couples processor 328 to a first plurality of devices (e.g., processors such as processor 211) associated with a first device type and a second communication interface that communicatively couples processor 328 to a second plurality of devices (e.g., accelerators such as accelerator 212) associated with a second device type, and potentially other communication interfaces that communicatively couple processor 328 to other respective pluralities of devices associated with respective device types. In this embodiment, processor 328 can collect first telemetry data from devices in the first plurality of devices via the first communication interface, second telemetry data from devices in the second plurality of devices via the second communication interface, and potentially other telemetry data from devices in the other respective pluralities of devices via the other respective communication interfaces. In one example implementation, devices in a plurality of devices associated with a particular device type may be physically proximate to each other, such as being stored in the same rack of a datacenter. The telemetry data collected for a given plurality of devices may be associated with an interface identifier that uniquely identifies the particular communication interface in the IPU that couples processor 328 to the given plurality of devices. Thus, telemetry data requests can specify a particular group of devices based on the IPU and the particular communication interface of the IPU that connects the group of devices to the IPU.

FIG. 4 is a block diagram illustrating a logical level of data abstraction in a telemetry data store 400, according to at least one embodiment. Telemetry data store 400 represents a possible implementation of telemetry data store 150 in telemetry data platform 140 and may have any suitable characteristics as described with reference to telemetry data store 150. Telemetry data store 400 may be embodied as any suitable data storage and retrieval system including, but not necessarily limited to a database (e.g., relational, NoSQL, object-oriented, key-value, hierarchical, time series, etc.), table, linked list, and more. In some implementations, telemetry data store 400 may be provisioned on one or more mass storage devices (e.g., direct-access storage device (DASDs)) or other suitable storage depending on particular implementations and needs.

Each instance of telemetry data in telemetry data store 400 may be linked, mapped, or otherwise associated with one or more of an IPU ID the IPU from which the telemetry data was received, a date and time the telemetry data was collected or generated, and a job ID representing a particular job or workload (e.g., an application, microservice, container, tenant) that was running when the telemetry data was collected or generated. In some embodiments, each instance of telemetry data may also be linked, mapped, or otherwise associated with other relevant information such as a device ID representing a particular device (e.g., CPU, GPU, SSD, HDD, etc.) on which the job associated with the telemetry data was provisioned. In some implementations, for telemetry data collected from a NIC of the IPU, the device ID may identify the NIC. In yet further embodiments, each instance of telemetry data may also be linked, mapped, or otherwise associated with other information such as a type ID representing a type of telemetry data (e.g., CPU usage, memory bandwidth, etc.). Each instance of telemetry data, its associated IPU ID, and other associated relevant information (e.g., job ID, data and time information, device ID, telemetry type ID) may form a unique set of data (also referred to herein as a “data collection”) in the data store.

By way of example only, telemetry data store 400 shows the data organized by IPU IDs 402(1)-402(N). Each instance of telemetry data is uniquely associated with the IPU that collected and published that instance of telemetry data to the telemetry data platform. For example, telemetry data 412(1)(1)-412(1)(X) is uniquely associated with IPU ID 402(1), telemetry data 412(2)(1)-412(2)(Y) is uniquely associated with IPU ID 402(2), and telemetry data 412(N)(1)-412(N)(Z) is uniquely associated with IPU ID 402(N). In one or more embodiments, each instance of the telemetry data may also be uniquely associated with an instance of the other information (e.g., data and time information 404, job ID 406, device ID 408, and/or type ID 410). However, the other information may or may not be uniquely associated with the telemetry data or the IPU IDs. For example, telemetry data collected and published by two or more IPUs may have been collected (or generated) at the same date/time. Additionally, a job may run on multiple nodes (e.g., compute node, memory node, accelerator node). Consequently, multiple IPUs may collect and publish respective instances of telemetry data related to that job, resulting in multiple IPU IDs being associated with the same job ID for one or more instances of telemetry data. In some scenarios, a device ID might be the same for the same device contained in different nodes. In other scenarios, a device ID may be unique across all nodes coupled to the IPUs.

In one example implementation, telemetry data store 400 a different data collection may be stored for each unique combination of an instance of telemetry data (e.g., 412(1)(1)), an IPU ID (e.g., 402(1)), date and time information, and a job ID. In some embodiments, other information may also be included in the data collection to provide additional granularity, such as a device ID and/or a telemetry type ID. Generally, a data collection may be embodied as any storage structure in which two or more data entries are linked, mapped, or otherwise associated with each other, such that queries can be performed to retrieve records containing any selected combination of data entries.

An authorized entity (e.g., 160) may request telemetry data related to a particular workload. The authorized entity may be the owner of the workload, an application itself if it performs its own performance and/or health monitoring, data and/or log analytics software, microservices health monitoring and alerting software tool, or another authorized entity. Typically, when an orchestrator (e.g., 140) schedules a workload, the orchestrator may return a job ID, which represents the workload deployed to run on one or more hardware devices in the computing infrastructure, to the workload owner (or other authorized entity). The job ID can be used to query the orchestrator (e.g., via orchestrator provided APIs and/or other orchestrator provided tools), to identify the nodes on which the workload is running. Thus, the relevant IPU IDs for the workload may be obtained in this manner. In one or more embodiments, the job ID and its associated IPU IDs may be used to query the orchestrator to identify a list of one or more devices (e.g., CPU, GPU, SSD, HDD, DRAM, etc.) per IPU that a workload is using.

The authorized entity may obtain telemetry data related to a workload deployed in a computing infrastructure based on one or more IPU IDs (e.g., compute node, memory node, accelerator node, storage node, network node, etc.) associated with the workload, a time period during which the workload was running, and/or other relevant information that may be available (e.g., device ID, type ID). For example, the authorized entity may send a query to the telemetry data platform (e.g., 140) using a suitable protocol, such as an enabled REST API, and specifying the job ID, one or more IPU IDs, and a time period, which could span any specified amount of time such as seconds, minutes, hours, days, weeks, etc. Accordingly, the authorized entity would receive telemetry data from the telemetry data store 400 that was collected by the specified IPU IDs during the specified time period while the workload represented by the specified job ID was executing and using one or more devices contained in the nodes represented by the IPU IDs. In a more specific example, an authorized entity may send a query (via an API) to request the last hour average utilization data of CPU #1 in IPU #1 and CPU #2 in IPU #2. The telemetry data platform would provide utilization data from the telemetry data store 400 that was collected during the specified time period (e.g., the last hour) by the specified IPUs #1 and #2 for the respective CPUs #1 and #2. In some scenarios, if device ID and/or type ID is available information, the authorized entity may further narrow the query for the telemetry data using one or both parameters. Furthermore, it should be apparent that, in at least some embodiments, a query may be performed by the authorized entity using any combination of parameters (e.g., IPU ID, job ID, time period or specific date and time, device ID, and/or type ID) to obtain telemetry data that is relevant to the specified combination of parameters. Queries may be restricted based on whether the authorized entity is authorized to access the information within the scope of the query.

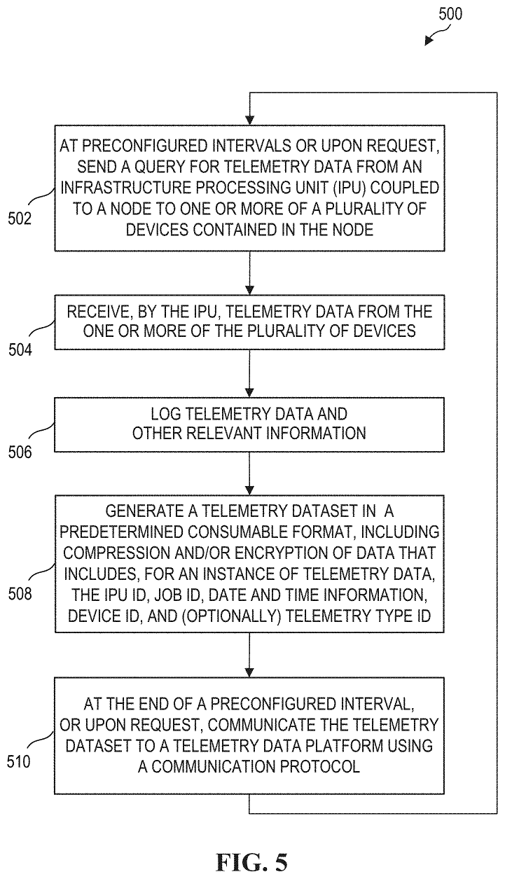

FIG. 5 is a flowchart depicting example operations of a flow 500 for collecting telemetry data at an IPU according to at least one embodiment. In at least one embodiment, one or more operations correspond to activities of FIG. 5. IPUs (e.g., 120(1)-120(6), 300), or respective portions thereof, may utilize the one or more operations. The IPUs may comprise means, such as respective processors (e.g., processor 328) for performing the operations. With reference to IPU 300 as an example, at least some of the operations shown in flow 500 may be performed by telemetry agent 322 and/or reporting logic 323.

Telemetry data may be collected by an IPU from one or more devices coupled to the IPU in a node (e.g., compute node 111, accelerator node 112, memory node 113, storage node 114, network node 115, or other node 116, etc.) in a computing infrastructure, such as computing infrastructure 110. IPUs may also collect telemetry data from interfaces of the devices in the node and/or interfaces (e.g., network interface, interconnect interface) of the IPU itself. In some implementations, an IPU may collect telemetry data regularly based upon a preconfigured interval. In other implementations, an IPU may collect telemetry data as needed, for example, when queried by a telemetry data platform. In yet further implementations, an IPU may collect telemetry data both at regular intervals and periodically, as needed. Preconfigured intervals may be specific to each IPU, a group of IPUs, a computing infrastructure, or a telemetry data platform. In yet further implementations, devices and their interfaces may provide a continuous feed to the IPU to which they are coupled with at least some of their telemetry data.

At 502, a query is sent for telemetry data from an IPU of a node to one or more devices of a plurality of devices contained in the node. At 504, the IPU receives telemetry data from the one or more devices (and their interfaces) of the plurality of devices contained in the node, and from interfaces within the IPU itself.

At 506, the received telemetry data may be logged by the IPU in a telemetry log (e.g., 324). For example, each instance of telemetry data received by the IPU may be stored in a telemetry log, such as telemetry log 324. In at least one embodiment, each instance of telemetry data may be stored in a record, row, or other suitable data storage structure, along with other relevant information. Other relevant information for an instance of telemetry data could include, for example, IPU identifier 321, date and time information, a device ID of the device corresponding to the instance of telemetry data, a job ID of the workload provisioned on the device, and optionally, a telemetry type ID of the instance of telemetry data.

At 508, a telemetry dataset may be generated based on one of the log records, or potentially on multiple log records. The dataset may be generated using a predetermined format that is consumable by the telemetry data platform. For example, a dataset may include an instance of collected telemetry data and other information relevant to the instance of telemetry data. The other information includes the IPU ID, a job ID, and date and time information. The other information may also include a device ID and telemetry type ID. In at least one embodiment, a suitable compression technique and/or an encryption algorithm may be performed on the dataset.

At 510, the generated dataset, which may be compressed and encrypted in at least some implementations, may be communicated to the telemetry data platform using any suitable communication protocol. In some implementations, datasets may be communicated to the telemetry data platform continuously, or based upon a preconfigured interval and/or upon request. Additionally, the telemetry log may be flushed regularly and/or periodically.

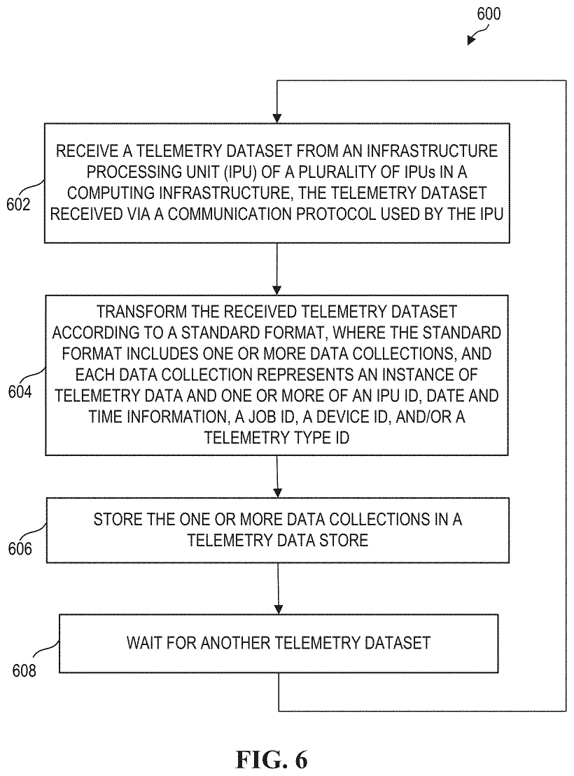

FIG. 6 is a flowchart depicting example operations of a flow 600 for receiving telemetry datasets at a telemetry data platform (e.g., telemetry data platform 140) from one or more IPUs (e.g., 120(1)-120(6), 300) according to an embodiment. In at least one embodiment, one or more operations correspond to activities of FIG. 6. The telemetry data platform (e.g., 140), or a portion thereof, may utilize the one or more operations. The telemetry data platform may comprise means, such as processor 148, for performing the operations, and telemetry data store 150, 400, for storing telemetry data and parameters for fast retrieval. In one example, at least some of the operations shown in flow 600 may be performed by data receiver logic, such as data receiver logic 142 in telemetry data platform 140.

At 602, a telemetry data platform (e.g., 140) receives a dataset from an infrastructure processing unit (IPU) of a plurality of IPUs (e.g., 120(1)-120(6)) in a computing infrastructure (e.g., 110). The dataset may contain an IPU ID representing the sending IPU and one or more instances of telemetry data collected by the sending IPU. The dataset may be received via a communication protocol used by the IPU. The telemetry data platform may be configured with different communication protocols to accommodate a variety of IPUs configured with different communication protocols.

At 604, the dataset received by telemetry data platform 140 is transformed according to a standard format that accommodates one or more data collections. Initially, if the received dataset is encrypted, then it can be decrypted, and if the received dataset is compressed, then it can be decompressed. The standard format may be any suitable format that enables fast searching and retrieval for search queries. In one example, the decrypted and decompressed dataset may be transformed into one or more data records, datasets, arrays, linked lists, tables, or more. In at least one embodiment, each data collection includes an IPU ID, a job ID, date and time information, and an instance of telemetry data. In some embodiments, each data collection may also include a device ID and/or a telemetry type ID.

At 606, the one or more data collections may be stored in the telemetry data store (e.g., 150, 400). In at least one embodiment, the one or more data collections may be stored according to the categories of information in the collections such as IPU ID, data and time information, a job ID. Optionally, a device ID and/or a telemetry type ID may also be categories of information included in each data collection. The structure of the data store enables the elements of the data collection (e.g., telemetry data, IPU ID, job ID, date and time information, device ID, and type ID) to be mapped, linked, or otherwise associated with each other. In some implementations, some elements of a dataset may not need to be stored in the data store but instead, may be associated with the other elements of the dataset that are stored. For example, IPU IDs and their associated device IDs may be stored a priori in the data store. Thus, for a given dataset, the telemetry data, job ID, date and time information, and type ID may be stored in the data store and associated with each other and with the appropriate IPU ID and device ID. In other implementations, each element of a data collection derived from given dataset may be stored in the data store in a manner that causes the elements of the data set to be associated.

At 608, the telemetry data platform waits for another dataset to be received from one of the IPUs of the plurality of IPUs in the computing infrastructure. Once another dataset is received, the flow 600 may begin again at 602 with the new dataset. This processing may continue as long as IPUs in the computing infrastructure are sending datasets of telemetry data to the telemetry data platform.

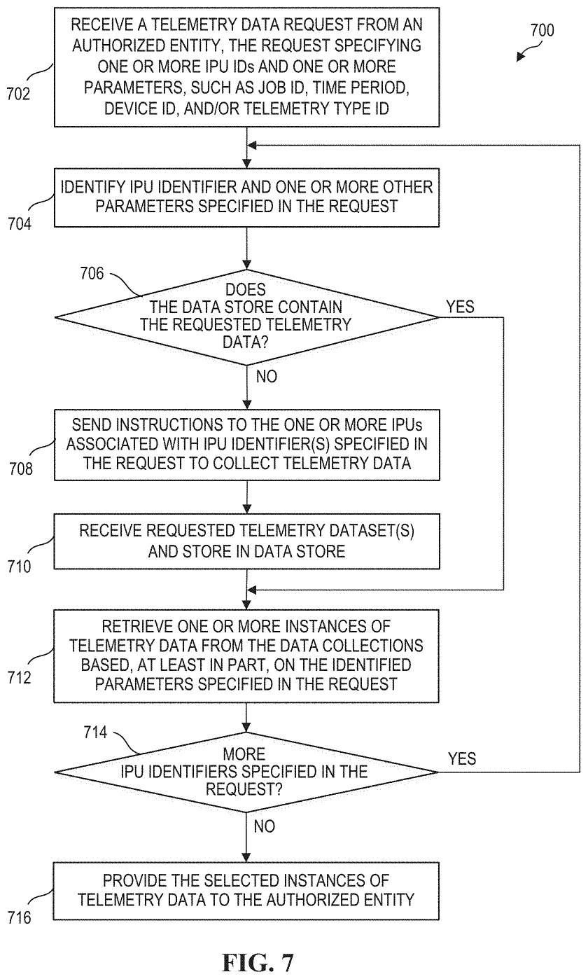

FIG. 7 is a flowchart depicting example operations of a flow 700 for a telemetry data platform (e.g., telemetry data platform 140) receiving and responding to telemetry data requests from an authorized entity (e.g., authorized entity 160). In at least one embodiment, one or more operations correspond to activities of FIG. 7. A telemetry data platform (e.g., 140) or portions thereof, may utilize the one or more operations. The telemetry data platform may comprise means, such as processor 148, for performing the operations, and telemetry data store 150, 400, for performing fast retrieval of telemetry data. With reference to telemetry data platform 140 as a nonlimiting example, at least some of the operations shown in flow 700 may be performed by data provider logic 144 and data receiver logic 142.

At 702, the telemetry data platform receives a telemetry data request from an authorized entity such as, for example, a use case owner, the microservice or other application itself for which telemetry data is requested, data and/or log analytics software, or microservices health monitoring tools. The telemetry data request specifies one or more IPU IDs and one or more other parameters based on the categories of other relevant information associated with the telemetry data. For example, the other parameters of the telemetry data request could include one or more of a date and time (or time period), job ID, device ID, and telemetry type ID.

At 704, an IPU ID and the one or more other parameters (if any) specified in the telemetry data request are identified. In at least one embodiment, the authorized entity may be authenticated prior to sending the telemetry request. Another layer of security may be provided to determine whether the authorized entity is authorized to request the particular telemetry data being requested. For example, authorized entities may have different levels of authorization and may only be allowed to request certain telemetry data. For example, an authorized entity may be authorized to request telemetry data associated with a workload that the authorized entity owns but may not be authorized to request telemetry data associated with a workload of another owner.

At 706, a determination is made as to whether the data store contains the requested telemetry data. If the data store does not contain telemetry data that is associated with the identified IPU and other parameter(s), then the data store does not contain the requested telemetry data. In this scenario, at 708, the telemetry data platform can send instructions to the IPU identified by the IPU ID in the request to collect telemetry based on the one or more parameters specified in the telemetry data request, such as job ID, device ID, and/or telemetry type ID. In some embodiments, a data and time (or time period) parameter may be used by the IPU if telemetry data was collected during that time period and is still stored in the telemetry data log.

At 710, the telemetry data platform receives a dataset from the IPU. If multiple IPU IDs were specified in the request, then multiple datasets may be received in response to the instructions. The telemetry data in the dataset(s) can be arranged and stored by functional categories in the data store of the telemetry data platform.

At 712, the data store can be searched based on the identified IPU ID and the identified other parameter(s), if any, from the telemetry data request. One or more instances of telemetry data can be retrieved from the data collections in the data store based, at least in part, on the identified IPU ID and the identified other parameter(s), if any. For example, time period parameter may encompass multiple instances of telemetry data associated with the IPU and any other specified parameters. In another example, if the specified parameters include an IPU ID, a job ID, and a time period, all of the telemetry data collected by the IPU that is associated with the workload identified by the specified job ID during the specified time period would be retrieved.

At 714, a determination can be made as to whether more IPU IDs are specified in the telemetry data request. If the request specifies additional IPU IDs, then the flow may return to 704, where the new IPU ID in the request is identified and the flow continues.

Once all the IPU IDs in the request have been identified, and telemetry data associated with those IPU IDs (and the other parameters) has been retrieved, then at 716, the retrieved telemetry data can be provided to the authorized entity. In some embodiments, the IPU ID(s) and parameter(s) in the telemetry data request may also be provided with the associated telemetry data to the authorized entity.

An example scenario for flow 700 includes a telemetry data request that specifies a first IPU ID for a compute node, a second IPU ID for a memory node, a third IPU ID for a storage node, and a job ID for a workload running on the specified IPU IDs. In this example, all instances of the telemetry data related to the workload identified by the job ID that were collected by the IPUs corresponding to the first, second, and third IPU IDs ae retrieved from the data store in response to the telemetry data request.

In another scenario, a time period may also be specified in the telemetry data request. Data and time information (e.g., indicating the collection or generation of telemetry data) associated with telemetry data may be compared to the specified time period to determine whether the telemetry data was collected or generated within the specified time period. Thus, the amount of telemetry data can be reduced while targeting a particular time period (which may be a period of seconds, minutes, hours, days, etc.) when problems with the workload are occurring.

In a further example, a device ID of a particular device (e.g., a CPU in a compute node, a GPU in an accelerator node, an SSD in a storage node, etc.) may be specified in the request to obtain targeted telemetry data associated with a particular device. In another example, a telemetry data request may specify multiple IPU IDs and corresponding device IDs, which may be the same type of devices (e.g., certain types of SSDs in multiple storage nodes) to obtain information on how particular devices are performing.

Numerous other combinations of categories can be used to obtain particular telemetry data to provide targeted telemetry information. The ability to obtain telemetry data across multiple nodes using parameters and IPU IDs to target specified cross-sections of data can enable resolutions of problems with particular devices, with workloads, with nodes, during certain time periods, or even with entire computing infrastructures or multiple computing infrastructures. Moreover, such information can be used to create meaningful KPIs that can be used to leverage artificial intelligence to enhance efficiency and use of data in real-time.

An illustrative example of a use case KPI that may be enabled by one or more embodiments of data mesh system 100 as disclosed herein, will now be described. Consider a high performance computing application that is deployed over multiple nodes in a computing infrastructure, such as computing infrastructure 110. The application is running very slowly, uses a significant amount of memory, and is CPU intensive. The user may not know if the root of the problem is the application, a particular node where the application is deployed, a particular device in a node where the application is deployed, network communications involving the application or involving hardware where the application is deployed, or something else. In an embodiment as described herein, the owner of the application can send an API with a telemetry data request to obtain selected telemetry data to obtain telemetry data that can provide an understanding of the computing infrastructure as a whole as well as the nodes and specific devices within the nodes that are hosting the workload, and also the networking communications between the relevant nodes. Such information can provide significant insights into the problem with the application. The owner can request telemetry data based on any combination of IPU IDs identifying IPUs where the application is deployed, job ID identifying the executing application (or workload), a time period, device ID(s) identifying particular devices where the application is deployed, and/or telemetry type ID(s) identifying particular types of telemetry data. Thus, the owner can efficiently create one or more KPIs to pinpoint and resolve problems.

“Logic” (e.g., as found in data receiver logic 142, data provider logic 144, telemetry agent 322, reporting logic 323, or in other references to logic in this application) may refer to hardware, firmware, software or any suitable combination thereof to perform one or more functions. In various embodiments, logic may include a microprocessor or other processing device or element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software. Software may be embodied as a software package, code, instructions, instruction sets and/or data recorded on non-transitory computer readable storage medium. Firmware may be embodied as code, instructions or instruction sets, and/or data that are hard-coded (e.g., nonvolatile) in memory devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected or capable of being interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘configured to,’ ‘capable of/to,’ and/or ‘operable to,’ in one embodiment, refers to some apparatus, logic, hardware, and/or element designed in such a way to enable use of the apparatus, logic, hardware, and/or element in a specified manner. Note that use of to, configured to, capable of/to, or operable to, in one embodiment, refers to the latent state of an apparatus, logic, hardware, and/or element, where the apparatus, logic, hardware, and/or element is not operating but is designed in such a manner to enable use of an apparatus in a specified manner.

The embodiments of methods, hardware, software, firmware, or code set forth above may be implemented via instructions or code stored on one or more machine-accessible storage media, machine readable storage media, computer accessible storage media, or computer readable media that are executable by one or more processing elements. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); read-only memory (ROM); magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other memory or storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

As used herein, unless expressly stated to the contrary, use of the phrase ‘at least one of’ refers to any combination of the named items, elements, conditions, operations, claim elements, or activities. For example, ‘at least one of X, Y, and Z’ is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z.

Additionally, unless expressly stated to the contrary, the terms ‘first’, ‘second’, ‘third’, etc., are intended to distinguish the particular items (e.g., element, condition, module, activity, operation, claim element, etc.) they modify, but are not intended to indicate any type of order, rank, importance, temporal sequence, or hierarchy of the modified item. For example, ‘first X’ and ‘second X’ are intended to designate two separate X elements that are not necessarily limited by any order, rank, importance, temporal sequence, or hierarchy of the two elements.

Reference throughout this specification to “one embodiment,” “an embodiment,” “at least one embodiment,” “one or more embodiments,” means that a particular feature, structure, or characteristic described in connection with the embodiment is included in at least one embodiment of the present disclosure. Thus, the appearances of the aforementioned phrases (or similar phrases) in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of “embodiment” and other exemplarily language does not necessarily refer to the same embodiment or the same example, but may refer to different and distinct embodiments, as well as potentially the same embodiment.

The following examples pertain to embodiments in accordance with this specification. The system, apparatus, method, and machine readable storage medium embodiments can include one or a combination of the following examples:

Example C1 provides one or more machine readable storage media comprising instructions stored thereon, the instructions when executed by a machine, cause the machine to receive a plurality of telemetry datasets from a plurality of infrastructure processing units (IPUs) in a computing infrastructure, and each of the plurality of IPUs is to be operably coupled to a plurality of devices having a particular device type. The plurality of telemetry datasets is to include a first telemetry dataset received from a first infrastructure processing unit (IPU) of the plurality of IPUs and a second telemetry dataset received from a second IPU of the plurality of IPUs. The instructions, when executed are to cause the machine further to store first telemetry data from the first telemetry dataset in a data store, store second telemetry data from the second telemetry dataset in the data store, and receive a telemetry data request that specifies a first IPU identifier identifying the first IPU and a job identifier, in response to receiving the telemetry data request, retrieve the first telemetry data from the data store based, at least in part, on the first telemetry data being associated with the first IPU identifier and the job identifier, and provide the first telemetry data to an authorized entity.

Example C2 comprises the subject matter of Example C1, and each of the plurality of IPUs in the computing infrastructure is integrated in one of a compute node containing two or more central processing units, a storage node containing two or more storage devices, an accelerator node containing two or more accelerators, a memory node containing two or more memory devices, or a network node containing two or more network devices.

Example C3 comprises the subject matter of any one of Examples C1-C2, and each of the plurality of telemetry datasets is to include information representing one or more of processor cache usage, processor cache bandwidth, available processor cache, memory bandwidth, memory usage, available memory, input/output bandwidth by each virtual guest system, bandwidth of each input/output device, utilization metrics, error metrics, computing power, memory access metrics, or redundancy of devices.

Example C4 comprises the subject matter of any one of Examples C1-C3, and the first telemetry dataset is to include the first telemetry data, the first IPU identifier, first date and time information, and the job identifier, and the second telemetry dataset is to include the second telemetry data, a second IPU identifier, second date and time information, and the job identifier.

Example C5 comprises the subject matter of any one of Examples C1-C4, and the instructions when executed by the machine are to cause the machine further to, in response to receiving the first telemetry dataset, associate the first telemetry data with the first IPU identifier in the data store, and in response to receiving the second telemetry dataset, associate the second telemetry data with the second IPU identifier in the data store.

Example C6 comprises the subject matter of any one of Examples C4-05, and the job identifier is to identify a workload deployed on a first device of a first plurality of devices coupled to the first IPU and on a second device of a second plurality of devices coupled to the second IPU.

Example C7 comprises the subject matter of Example C6, and the instructions when executed by the machine are to cause the machine further to, in response to receiving the first telemetry dataset, associate the first telemetry data with the job identifier in the data store, and in response to receiving the second telemetry dataset, associate the second telemetry data with the job identifier in the data store.

Example C8 comprises the subject matter of any one of Examples C4-C7, and the first telemetry dataset is to include a first device identifier identifying a first device of a first plurality of devices coupled to the first IPU, and the second telemetry dataset is to include a second device identifier identifying a second device of a second plurality of devices coupled to the second IPU.

Example C9 comprises the subject matter of Example C8, and the instructions when executed by the machine are to cause the machine further to, in response to receiving the first telemetry dataset, associate the first telemetry data with the first device identifier in the data store, and in response to receiving the second telemetry dataset, associate the second telemetry data with the second device identifier in the data store.

Example C10 comprises the subject matter of Example C9, and the telemetry data request further specifies the first device identifier, and the first telemetry data in the data store is to be retrieved based, in part, on the first device identifier in the data store being associated with the first telemetry data in the data store.

Example C11 comprises the subject matter of any one of Examples C4-C10, and the first date and time information corresponds to generating or collecting the first telemetry data, and the second date and time information corresponds to generating or collecting the second telemetry data.

Example C12 comprises the subject matter of Example C11, and the instructions when executed by the machine are to cause the machine further to, in response to receiving the first telemetry dataset, associate the first telemetry data with the first date and time information in the data store, and in response to receiving the second telemetry dataset, associate the second telemetry data with the second date and time information in the data store.

Example C13 comprises the subject matter of Example C12, and the telemetry data request further specifies a time period, and the first telemetry data in the data store is to be retrieved based, in part, on the first date and time information in the data store being associated with the first telemetry data and being within the time period.

Example C14 comprises the subject matter of any one of Examples C1-C13, and the instructions when executed by the machine are to cause the machine further to receive, via a first communication protocol, the first telemetry dataset from the first IPU of the plurality of IPUs, and receive, via a second communication protocol, the second telemetry dataset from the second IPU of the plurality of IPUs.

Example C15 comprises the subject matter of any one of Examples C1-C14, and the computing infrastructure is disaggregated.

Example A1 provides a method comprising a memory element including a data store and a processor coupled to the memory element. The processor is to receive a plurality of telemetry datasets from a plurality of infrastructure processing units (IPUs) in a computing infrastructure, and each of the plurality of IPUs is to be operably coupled to a plurality of devices having a particular device type, and the plurality of telemetry datasets is to include a first telemetry dataset received from a first infrastructure processing unit (IPU) of the plurality of IPUs and a second telemetry dataset received from a second IPU of the plurality of IPUs. The processor is further to store first telemetry data from the first telemetry dataset in the data store, and store second telemetry data from the second telemetry dataset in the data store. The processor is further to, in response to receiving a telemetry data request that specifies a first IPU identifier identifying the first IPU, a second IPU identifier identifying the second IPU, and a time period, retrieve the first telemetry data from the data store based, at least in part, on the first telemetry data being associated with the first IPU identifier and first date and time information being within the time period, and retrieve the second telemetry data from the data store based, at least in part, on the second telemetry data being associated with the second IPU identifier and second date and time information being within the time period. The processor is further to send the first telemetry data and the second telemetry data to an authorized entity.

Example A2 comprises the subject matter of Example A1, and each of the plurality of IPUs in the computing infrastructure is integrated in one of a compute node containing two or more central processing units, a storage node containing two or more storage devices, an accelerator node containing two or more accelerators, a memory node containing two or more memory devices, or a network node containing two or more network devices.

Example A3 comprises the subject matter of any one of Examples A1-A2, and each of the plurality of telemetry datasets is to include information representing one or more of: processor cache usage, processor cache bandwidth, available processor cache, memory bandwidth, memory usage, available memory, input/output bandwidth by each virtual guest system, bandwidth of each input/output device, utilization metrics, error metrics, computing power, memory access metrics, or redundancy of devices.

Example A4 comprises the subject matter of any one of Examples A1-A3, and the first telemetry dataset is to include the first telemetry data, the first IPU identifier, and the first date and time information, and the second telemetry dataset is to include the second telemetry data, a second IPU identifier, and the second date and time information.

Example A5 comprises the subject matter of Example A4, and the processor is further to, in response to receiving the first telemetry dataset, associate the first telemetry data with the first IPU identifier in the data store, and in response to receiving the second telemetry dataset, associate the second telemetry data with the second IPU identifier in the data store.

Example A6 comprises the subject matter of any one of Examples A4-A5, and the first telemetry dataset is to include a job identifier identifying a workload deployed on a first device of a first plurality of devices coupled to the first IPU and on a second device of a second plurality of devices coupled to the second IPU.

Example A7 comprises the subject matter of Example A6, and the processor is further to, in response to receiving the first telemetry dataset, associate the first telemetry data with the job identifier in the data store, and in response to receiving the second telemetry dataset, associate the second telemetry data with the job identifier in the data store.

Example A8 comprises the subject matter of Example A7, and the telemetry data request further specifies the job identifier, and the first telemetry data in the data store is to be retrieved based, in part, on the job identifier in the data store being associated with the first telemetry data in the data store.

Example A9 comprises the subject matter of any one of Examples A4-A8, and the first telemetry dataset is to include a first device identifier identifying a first device of a first plurality of devices coupled to the first IPU, and the second telemetry dataset is to include a second device identifier identifying a second device of a second plurality of devices coupled to the second IPU.

Example A10 comprises the subject matter of Example A9, and the processor is further to, in response to receiving the first telemetry dataset, associate the first telemetry data with the first device identifier in the data store, and in response to receiving the second telemetry dataset, associate the second telemetry data with the second device identifier in the data store.

Example A11 comprises the subject matter of Example A10, and the telemetry data request further specifies the first device identifier, and the first telemetry data in the data store is to be retrieved based, in part, on the first device identifier in the data store being associated with the first telemetry data in the data store.

Example A12 comprises the subject matter of any one of Examples A4-A11, and the first date and time information corresponds to generating or collecting the first telemetry data, and the second date and time information corresponds to generating or collecting the second telemetry data.

Example A13 comprises the subject matter of Example A12, and the processor is further to, in response to receiving the first telemetry dataset, associate the first telemetry data with the first date and time information in the data store, and in response to receiving the second telemetry dataset, associate the second telemetry data with the second date and time information in the data store.

Example A14 comprises the subject matter of Example A13, and the telemetry data request further specifies a time period, and the first telemetry data in the data store is to be retrieved based, in part, on the first date and time information in the data store being associated with the first telemetry data and being within the time period.

Example A15 comprises the subject matter of any one of Examples A1-A14, and the processor is further to receive, via a first communication protocol, the first telemetry dataset from the first IPU of the plurality of IPUs, and receive, via a second communication protocol, the second telemetry dataset from the second IPU of the plurality of IPUs.

Example A16 comprises the subject matter of any one of Examples A1-A15, and the computing infrastructure is disaggregated.

Example M1 provides a method comprising receiving, by a processor in a platform, a plurality of telemetry datasets from a plurality of infrastructure processing units (IPUs) in a computing infrastructure, and each of the plurality of IPUs is operably coupled to a plurality of devices having a particular device type, and the plurality of telemetry datasets includes a first telemetry dataset received from a first infrastructure processing unit (IPU) of the plurality of IPUs and a second telemetry dataset received from a second IPU of the plurality of IPUs. The method further comprises storing first telemetry data from the first telemetry dataset in a data store, and storing second telemetry data from the second telemetry dataset in the data store. The method further comprises, in response to receiving a telemetry data request that specifies a first IPU identifier identifying the first IPU and a job identifier, retrieving the first telemetry data from the data store based, at least in part, on the first telemetry data being associated with the first IPU identifier and the job identifier. The method further comprises providing the first telemetry data to an authorized entity.

Example M2 comprises the subject matter of Example M1, and the first IPU and the second IPU are each integrated in a respective one of a compute node containing two or more central processing units, a storage node containing two or more storage devices, an accelerator node containing two or more accelerators, a memory node containing two or more memory devices, or a network node containing two or more network devices.

Example M3 comprises the subject matter of any one of Examples M1-M2, and each of the plurality of telemetry datasets is to include information representing one or more of: processor cache usage, processor cache bandwidth, available processor cache, memory bandwidth, memory usage, available memory, input/output bandwidth by each virtual guest system, bandwidth of each input/output device, utilization metrics, error metrics, computing power, memory access metrics, or redundancy of devices.

Example M4 comprises the subject matter of any one of Examples M1-M3, and the first telemetry dataset includes the first telemetry data, the first IPU identifier, first date and time information, and the job identifier, and the second telemetry dataset includes the second telemetry data, a second IPU identifier, second date and time information, and the job identifier.

Example M5 comprises the subject matter of Example M4, and further comprises associating the first telemetry data with the first IPU identifier in the data store in response to receiving the first telemetry dataset, and associating the second telemetry data with the second IPU identifier in the data store in response to receiving the second telemetry dataset.

Example M6 comprises the subject matter of any one of Examples M4-M5, and the job identifier identifies a workload deployed on a first device of a first plurality of devices coupled to the first IPU and on a second device of a second plurality of devices coupled to the second IPU.

Example M7 comprises the subject matter of Example M6, and further comprises associating the first telemetry data with the job identifier in the data store in response to receiving the first telemetry dataset, and associating the second telemetry data with the job identifier in the data store in response to receiving the second telemetry dataset.

Example M8 comprises the subject matter of any one of Examples M4-M7, and the first telemetry dataset includes a first device identifier identifying a first device of a first plurality of devices coupled to the first IPU, and the second telemetry dataset includes a second device identifier identifying a second device of a second plurality of devices coupled to the second IPU.

Example M9 comprises the subject matter of Example M8, and further comprises in response to receiving the first telemetry dataset, associating the first telemetry data with the first device identifier in the data store, and in response to receiving the second telemetry dataset, associating the second telemetry data with the second device identifier in the data store.

Example M10 comprises the subject matter of Example M9, and the telemetry data request further specifies the first device identifier, and the first telemetry data in the data store is retrieved based, in part, on the first device identifier in the data store being associated with the first telemetry data in the data store.

Example M11 comprises the subject matter of any one of Examples M4-M10, and the first date and time information corresponds to generating or collecting the first telemetry data, and the second date and time information corresponds to generating or collecting the second telemetry data.

Example M12 comprises the subject matter of Example M11, and further comprises, in response to receiving the first telemetry dataset, associating the first telemetry data with the first date and time information in the data store, and in response to receiving the second telemetry dataset, associating the second telemetry data with the second date and time information in the data store.

Example M13 comprises the subject matter of Example M12, and the telemetry data request further specifies a time period, and the first telemetry data in the data store is retrieved based, in part, on the first date and time information in the data store being associated with the first telemetry data and being within the time period.

Example M14 comprises the subject matter of any one of Examples M1-M13, and further comprises receiving, via a first communication protocol, the first telemetry dataset from the first IPU of the plurality of IPUs, and receiving, via a second communication protocol, the second telemetry dataset from the second IPU of the plurality of IPUs.

Example M15 comprises the subject matter of any one of Examples M1-M14, and the computing infrastructure is disaggregated.

Example S1 provides a system or apparatus, comprising a first infrastructure processing unit (IPU) operably coupled to a first plurality of devices having a first device type, and the first IPU includes a first IPU processor to collect a first plurality of telemetry data from the first plurality of devices. The system or apparatus further includes a second IPU operably coupled to a second plurality of devices having a second device type, and the second IPU includes a second IPU processor to collect a second plurality of telemetry data from the second plurality of devices. They system or apparatus further includes a telemetry data platform communicatively connected to the first IPU and the second IPU, the telemetry data platform comprising a processor to receive a first telemetry dataset including first telemetry data of the first plurality of telemetry data from the first IPU, store the first telemetry data in a data store, receive a second telemetry dataset including second telemetry data of the second plurality of telemetry data from the second IPU, store the second telemetry data in the data store, and in response to receiving a telemetry data request that specifies a first IPU identifier identifying the first IPU and a job identifier, retrieve the first telemetry data from the data store based, at least in part, on the first telemetry data being associated with the first IPU identifier and the job identifier. The first telemetry data is provided to an authorized entity.

Example S2 comprises the subject matter of Example S1, and the first IPU and the second IPU are each integrated in a respective one of a compute node containing two or more central processing units, a storage node containing two or more storage devices, an accelerator node containing two or more accelerators, a memory node containing two or more memory devices, or a network node containing two or more network devices.

Example S3 comprises the subject matter of any one of Examples S1-S2, and the first telemetry dataset and the second telemetry dataset each include information representing one or more of processor cache usage, processor cache bandwidth, available processor cache, memory bandwidth, memory usage, available memory, input/output bandwidth by each virtual guest system, bandwidth of each input/output device, utilization metrics, error metrics, computing power, memory access metrics, or redundancy of devices.

Example S4 comprises the subject matter of any one of Examples S1-S3, and the first telemetry dataset is to include the first telemetry data, the first IPU identifier, first date and time information, and the job identifier, and the second telemetry dataset is to include the second telemetry data, a second IPU identifier, second date and time information, and the job identifier.

Example S5 comprises the subject matter of any one of Examples S1-S4, and the first IPU processor is further to generate the first telemetry dataset, and the second IPU processor is further to generate the second telemetry dataset.

Example S6 comprises the subject matter of any one of Examples S1-S5, and the first IPU processor is further to send, via a first communication protocol, the first telemetry dataset to the telemetry data platform, and the second IPU processor is further to send, via a second communication protocol, the second telemetry dataset to the telemetry data platform.

Example S7 comprises the subject matter of any one of Examples S1-S6, and the computing infrastructure is disaggregated.

Example P1 provides an apparatus, a system, one or more machine readable storage mediums, a method, and/or hardware-, firmware-, and/or software-based logic, where the Example of P1 includes: an infrastructure processing unit (IPU) including a processor; a first interface to communicatively couple the processor to a first plurality of devices associated with a first device type; a second interface to communicatively couple the processor to a second plurality of devices associated with a second device type, and the processor is to collect a first plurality of telemetry data from the first plurality of devices via the first interface, collect a second plurality of telemetry data from the second plurality of devices via the second interface, generate at least one telemetry dataset including first telemetry data of the first plurality of telemetry data collected from the first plurality of devices and second telemetry data of the second plurality of telemetry data collected from the second plurality of devices, and provide the at least one telemetry dataset to a telemetry data platform.

Example P2, comprises the subject matter of Example P1, and the first plurality of devices includes at least two central processing units, at least two storage devices, at least two accelerators, at least two memory devices, or at least two network devices, and the second plurality of devices includes at least two other central processing units, at least two other storage devices, at least two other accelerators, at least two other memory devices, or at least two other network devices.

Example P3, comprises the subject matter of any one of Examples P1-P2, and the at least one telemetry dataset is to include information representing one or more of processor cache usage, processor cache bandwidth, available processor cache, memory bandwidth, memory usage, available memory, input/output bandwidth by each virtual guest system, bandwidth of each input/output device, utilization metrics, error metrics, computing power, memory access metrics, or redundancy of devices.

Example P4, comprises the subject matter of any one of Examples P1-P3, and the at least one telemetry dataset is to include a first telemetry dataset including the first telemetry data, an IPU identifier, a first interface identifier corresponding to the first interface, first date and time information, and a job identifier, and a second telemetry dataset including the second telemetry data, the IPU identifier, a second interface identifier corresponding to the second interface, second date and time information, and the job identifier.

Example P5, comprises the subject matter of Example P4, and the job identifier is to identify a workload deployed on a first device of the first plurality of devices coupled to the IPU via the first interface and on a second device of the second plurality of devices coupled to the IPU via the second interface.

Example P6, comprises the subject matter of any one of Examples P4-P5, and the first telemetry dataset is to include a first device identifier identifying the first device of the first plurality of devices, and the second telemetry dataset is to include a second device identifier identifying the second device of the second plurality of devices.

Example P7, comprises the subject matter of any one of Examples P4-P6, and the first date and time information corresponds to generating the first telemetry dataset or collecting the first telemetry data, and the second date and time information corresponds to generating the second telemetry dataset or collecting the second telemetry data.

Example P8, comprises the subject matter of any one of Examples P4-P7, and the processor is further to send the first telemetry dataset from the IPU to the telemetry data platform via a first communication protocol, and send the second telemetry dataset from the IPU to the telemetry data platform via the first communication protocol.

Example P9, comprises the subject matter of any one of Examples P4-P8, and the first telemetry dataset and the second telemetry dataset are contained in a single file or in separate files.

Example P10, comprises the subject matter of any one of Examples P1-P9, and the first plurality of telemetry data is collected based on a preconfigured interval or in response to a request from the telemetry data platform.

Example P11, comprises the subject matter of any one of Examples P1-P10, and the second plurality of telemetry data is collected based on a preconfigured interval or in response to a request from the telemetry data platform.

Example N1 provides an apparatus, the apparatus comprising means for receiving a plurality of telemetry datasets from a plurality of infrastructure processing units (IPUs) in a computing infrastructure, and each of the plurality of IPUs is operably coupled to a plurality of devices having a particular device type, and the plurality of telemetry datasets includes a first telemetry dataset received from a first infrastructure processing unit (IPU) of the plurality of IPUs and a second telemetry dataset received from a second IPU of the plurality of IPUs. The method further comprises means for storing first telemetry data from the first telemetry dataset in a data store, and means for storing second telemetry data from the second telemetry dataset in the data store. The method further comprises, means for retrieving the first telemetry data from the data store based, at least in part, on the first telemetry data being associated with the first IPU identifier and the job identifier in response to receiving a telemetry data request that specifies a first IPU identifier identifying the first IPU and a job identifier. The method further comprises means for providing the first telemetry data to an authorized entity.

An Example Y1 provides an apparatus, the apparatus comprising means for performing the method of any one of the Examples M1-M15 or P1-P11.

Example Y2 comprises the subject matter of Example Y1, and the means for performing the method comprises at least one processing device and at least one memory element.

Example Y3 comprises the subject matter of Example Y2, and the at least one memory element comprises machine readable instructions that when executed, cause the apparatus to perform the method of any one of Examples M1-M20.

Example Y4 comprises the subject matter of any one of Examples Y1-Y3, and the apparatus is a computing system.

An Example X1 provides at least one machine readable storage medium comprising instructions that, when executed, realizes an apparatus, implements a method, or realizes a system as in any one of Examples A1-A16, M1-M15, S1-S7 or P1-P11.

1. One or more machine readable storage media having instructions stored thereon, the instructions when executed by a machine are to cause the machine to:
receive a plurality of telemetry datasets from a plurality of infrastructure processing units (IPUs) in a computing infrastructure, wherein each of the plurality of IPUs is operably coupled to a plurality of devices having a particular device type, wherein the plurality of telemetry datasets is to include a first telemetry dataset received from a first infrastructure processing unit (IPU) of the plurality of IPUs and a second telemetry dataset received from a second IPU of the plurality of IPUs;
store first telemetry data from the first telemetry dataset in a data store;
store second telemetry data from the second telemetry dataset in the data store; and
receive a telemetry data request that specifies a first IPU identifier identifying the first IPU and a job identifier;
in response to receiving the telemetry data request, retrieve the first telemetry data from the data store based, at least in part, on the first telemetry data being associated with the first IPU identifier and the job identifier; and
provide the first telemetry data to an authorized entity.

2. The one or more machine readable storage media of claim 1, wherein each of the plurality of IPUs in the computing infrastructure is integrated in one of:
a compute node containing two or more central processing units;
a storage node containing two or more storage devices;
an accelerator node containing two or more accelerators;
a memory node containing two or more memory devices; or
a network node containing two or more network devices.

3. The one or more machine readable storage media of claim 1, wherein each of the plurality of telemetry datasets includes information representing one or more of: processor cache usage, processor cache bandwidth, available processor cache, memory bandwidth, memory usage, available memory, input/output bandwidth by each virtual guest system, bandwidth of each input/output device, utilization metrics, error metrics, computing power, memory access metrics, or redundancy of devices.

4. The one or more machine readable storage media of claim 1, wherein the first telemetry dataset includes the first telemetry data, the first IPU identifier, first date and time information, and the job identifier, and wherein the second telemetry dataset includes the second telemetry data, a second IPU identifier, second date and time information, and the job identifier.

5. The one or more machine readable storage media of claim 4, wherein the instructions when executed by the machine are to cause the machine further to:
in response to receiving the first telemetry dataset, associate the first telemetry data with the first IPU identifier in the data store; and
in response to receiving the second telemetry dataset, associate the second telemetry data with the second IPU identifier in the data store.

6. The one or more machine readable storage media of claim 4, wherein the job identifier is to identify a workload deployed on a first device of a first plurality of devices coupled to the first IPU and on a second device of a second plurality of devices coupled to the second IPU.

7. The one or more machine readable storage media of claim 6, wherein the instructions when executed by the machine are to cause the machine further to:
in response to receiving the first telemetry dataset, associate the first telemetry data with the job identifier in the data store; and
in response to receiving the second telemetry dataset, associate the second telemetry data with the job identifier in the data store.

8. The one or more machine readable storage media of claim 4, wherein the first telemetry dataset includes a first device identifier identifying a first device of a first plurality of devices coupled to the first IPU, and wherein the second telemetry dataset includes a second device identifier identifying a second device of a second plurality of devices coupled to the second IPU.

9. The one or more machine readable storage media of claim 8, wherein the instructions when executed by the machine are to cause the machine further to:
in response to receiving the first telemetry dataset, associate the first telemetry data with the first device identifier in the data store; and
in response to receiving the second telemetry dataset, associate the second telemetry data with the second device identifier in the data store.

10. The one or more machine readable storage media of claim 9, wherein the telemetry data request further specifies the first device identifier, wherein the first telemetry data in the data store is to be retrieved based, in part, on the first device identifier in the data store being associated with the first telemetry data in the data store.

11. The one or more machine readable storage media of claim 4, wherein the first date and time information corresponds to generating or collecting the first telemetry data, and wherein the second date and time information corresponds to generating or collecting the second telemetry data.

12. The one or more machine readable storage media of claim 11, wherein the instructions when executed by the machine are to cause the machine further to:
in response to receiving the first telemetry dataset, associate the first telemetry data with the first date and time information in the data store; and
in response to receiving the second telemetry dataset, associate the second telemetry data with the second date and time information in the data store.

13. The one or more machine readable storage media of claim 12, wherein the telemetry data request further specifies a time period, wherein the first telemetry data in the data store is to be retrieved based, in part, on the first date and time information in the data store being associated with the first telemetry data and being within the time period.

14. The one or more machine readable storage media of claim 1, wherein the instructions when executed by the machine are to cause the machine further to:
receive, via a first communication protocol, the first telemetry dataset from the first IPU of the plurality of IPUs; and
receive, via a second communication protocol, the second telemetry dataset from the second IPU of the plurality of IPUs.

15. The one or more machine readable storage media of claim 1, wherein the computing infrastructure is disaggregated.

16. An apparatus comprising:
a memory element including a data store; and
a processor coupled to the memory element, the processor to:
receive a plurality of telemetry datasets from a plurality of infrastructure processing units (IPUs) in a computing infrastructure, wherein each of the plurality of IPUs is operably coupled to a plurality of devices having a particular device type, wherein the plurality of telemetry datasets is to include a first telemetry dataset received from a first infrastructure processing unit (IPU) of the plurality of IPUs and a second telemetry dataset received from a second IPU of the plurality of IPUs;
store first telemetry data from the first telemetry dataset in the data store;
store second telemetry data from the second telemetry dataset in the data store; and
in response to receiving a telemetry data request that specifies a first IPU identifier identifying the first IPU, a second IPU identifier identifying the second IPU, and a time period:
retrieve the first telemetry data from the data store based, at least in part, on the first telemetry data being associated with the first IPU identifier and first date and time information being within the time period; and
retrieve the second telemetry data from the data store based, at least in part, on the second telemetry data being associated with the second IPU identifier and second date and time information being within the time period; and
send the first telemetry data and the second telemetry data to an authorized entity.

17. The apparatus of claim 16, wherein the first telemetry dataset includes the first telemetry data, the first IPU identifier, and the first date and time information, and wherein the second telemetry dataset includes the second telemetry data, the second IPU identifier, and the second date and time information.

18. The apparatus of claim 17, wherein the first date and time information corresponds to generating or collecting the first telemetry data, and wherein the second date and time information corresponds to generating or collecting the second telemetry data.

19. The apparatus of claim 18, wherein the processor is further to:
in response to receiving the first telemetry dataset, associate the first telemetry data with the first date and time information in the data store; and
in response to receiving the second telemetry dataset, associate the second telemetry data with the second date and time information in the data store.

20. A method comprising:
receiving, by a processor in a platform, a plurality of telemetry datasets from a plurality of infrastructure processing units (IPUs) in a computing infrastructure, wherein each of the plurality of IPUs is operably coupled to a plurality of devices having a particular device type, wherein the plurality of telemetry datasets includes a first telemetry dataset received from a first infrastructure processing unit (IPU) of the plurality of IPUs and a second telemetry dataset received from a second IPU of the plurality of IPUs;
storing first telemetry data from the first telemetry dataset in a data store;
storing second telemetry data from the second telemetry dataset in the data store;
in response to receiving a telemetry data request that specifies a first IPU identifier identifying the first IPU and a job identifier, retrieving the first telemetry data from the data store based, at least in part, on the first telemetry data being associated with the first IPU identifier and the job identifier; and
providing the first telemetry data to an authorized entity.

21. The method of claim 20, wherein the first telemetry dataset includes the first telemetry data, the first IPU identifier, first date and time information, and the job identifier, and wherein the second telemetry dataset includes the second telemetry data, a second IPU identifier, second date and time information, and the job identifier.

22. The method of claim 21, further comprising:
associating the first telemetry data with the first IPU identifier in the data store in response to receiving the first telemetry dataset; and
associating the second telemetry data with the second IPU identifier in the data store in response to receiving the second telemetry dataset.

23. The method of claim 21, further comprising:
associating the first telemetry data with the job identifier in the data store in response to receiving the first telemetry dataset; and
associating the second telemetry data with the job identifier in the data store in response to receiving the second telemetry dataset.

24. An apparatus comprising:
an infrastructure processing unit (IPU) including:
a processor;
a first interface to communicatively couple the processor to a first plurality of devices associated with a first device type;
a second interface to communicatively couple the processor to a second plurality of devices associated with a second device type;
wherein the processor is to:
collect a first plurality of telemetry data from the first plurality of devices via the first interface;
collect a second plurality of telemetry data from the second plurality of devices via the second interface;
generate at least one telemetry dataset including first telemetry data of the first plurality of telemetry data collected from the first plurality of devices and second telemetry data of the second plurality of telemetry data collected from the second plurality of devices; and
provide the at least one telemetry dataset to a telemetry data platform.

25. The apparatus of claim 24,
wherein the first plurality of devices includes at least two central processing units, at least two storage devices, at least two accelerators, at least two memory devices, or at least two network devices, and
wherein the second plurality of devices includes at least two other central processing units, at least two other storage devices, at least two other accelerators, at least two other memory devices, or at least two other network devices.
